(19) United States
(12) Patent Application Publication
(10) Pub. No.: US 2025/0125960 A1
(43) Pub. Date: Apr. 17, 2025

(54) DETECTING PATTERNS IN EVENT DATA

(71) Applicant: Capital One Services, LLC, McLean, VA (US)

(72) Inventors: Purna Prasanna Srikar Raju REGATI, Andhra Pradesh (IN); Rama Teja GAMPA, Hyderabad (IN)

(21) Appl. No.: 18/488,467

(22) Filed: Oct. 17, 2023

(51) Int. Cl. H04L 9/32

(52) U.S. Cl. CPC H04L 9/3213

(57) ABSTRACT

In some implementations, an event sequence system may identify a set of user interaction sequences indicating user interactions with an application. The event sequence system may tokenize the set of user interaction sequences to generate a vector representation that indicates, for a plurality of sub-sequences of the set of user interaction sequences, a number of occurrences of each of the plurality of sub-sequences within the set of user interaction sequences, the plurality of sub-sequences including sub-sequences of different lengths. The event sequence system may identify, based at least in part on the vector representation, a set of frequent user interaction sub-sequences that are included in the set of user interaction sequences.

### BACKGROUND

In the computing and networking context, event data may include any data associated with an even that is provided by hardware and/or software. Event data may be analyzed by various systems, including real-time event data analysis for performing actions in response to certain events, and/or non-real-time analysis for various purposes.

### SUMMARY

Some implementations described herein relate to a system for processing event data. The system may include one or more memories and one or more processors communicatively coupled to the one or more memories. The one or more processors may be configured to identify a set of user interaction sequences indicating user interactions with an application. The one or more processors may be configured to tokenize the set of user interaction sequences to generate a vector representation that indicates, for a plurality of sub-sequences of the set of user interaction sequences, a number of occurrences of each of the plurality of sub-sequences within the set of user interaction sequences, the plurality of sub-sequences including sub-sequences of different lengths. The one or more processors may be configured to identify, based at least in part on the vector representation, a set of frequent user interaction sub-sequences that are included in the set of user interaction sequences.

Some implementations described herein relate to a method for processing event data. The method may include identifying, by an event data processing system, a user interaction sequence indicating user interactions with an application. The method may include tokenizing, by the event data processing system, the user interaction sequence to generate a vector representation that indicates, for a plurality of sub-sequences of the user interaction sequence, a number of occurrences of each of the plurality of sub-sequences within the user interaction sequence, the plurality of sub-sequences including sub-sequences of different lengths. The method may include identifying, by the event data processing system and based at least in part on the vector representation, a set of frequent user interaction sub-sequences that are included in the user interaction sequence.

Some implementations described herein relate to a non-transitory computer-readable medium that stores a set of instructions. The set of instructions, when executed by one or more processors of a one or more instructions that, when executed by one or more processors of an event data processing system, may cause the one or more instructions that, when executed by one or more processors of an event data processing system to identify a user interaction sequence indicating user interactions with an application. The set of instructions, when executed by one or more processors of the one or more instructions that, when executed by one or more processors of an event data processing system, may cause the one or more instructions that, when executed by one or more processors of an event data processing system to tokenize the user interaction sequence to generate a vector representation that indicates, for a plurality of sub-sequences of the user interaction sequence, a number of occurrences of each of the plurality of sub-sequences within the user interaction sequence, the plurality of sub-sequences including sub-sequences of different lengths. The set of instructions, when executed by one or more processors of the one or more instructions that, when executed by one or more processors of an event data processing system, may cause the one or more instructions that, when executed by one or more processors of an event data processing system to identify, based at least in part on the vector representation, a set of frequent user interaction sub-sequences that are included in the user interaction sequence.

### BRIEF DESCRIPTION OF THE DRAWINGS

FIGS. 1A-1B are diagrams of an example associated with detecting patterns in event data, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with detecting patterns in event data, in accordance with some embodiments of the present disclosure.

FIG. 4 is a flowchart of an example process associated with detecting patterns in event data, in accordance with some embodiments of the present disclosure.

### DETAILED DESCRIPTION

The following detailed description of example implementations refers to the accompanying drawings. The same reference numbers in different drawings may identify the same or similar elements.

Analyzing event data often uses significant computing resources (e.g., processing resources, memory resources, communication resources, and/or power resources, among other examples), and the computational complexity generally increases as the amount of event data to be processed increases. For example, one goal of analyzing event data may be to identify patterns in the event data and, as pattern complexity increases and/or the amount and types of event data increases, it becomes computationally expensive to identify specific patterns. In addition, data analysis techniques may also be used to discover patterns in event data. The process of pattern discovery may also be computationally expensive, as advanced computing techniques, including machine learning, generative artificial intelligence, and other techniques, may require significant computing power to discover patterns in the event data.

Some implementations described herein include an event sequence system that detects patterns in event data in a computationally efficient manner. For example, the event sequence system may identify event sequences from the event data (e.g., event data that includes time-ordered sequences of events) and tokenize the event sequences to generate a vector representation for the event sequences. The vector representation may indicate, for multiple sub-sequences of different lengths, a number of occurrences of the sub-sequences in the event sequences. The vector representation may then be used to identify patterns in the data, for example, by surfacing (e.g., detecting) the most frequent sub-sequences and/or identifying a number of occurrences of specific sub-sequences.

In this way, the event sequence system enables the identification of patterns in data that would otherwise be difficult and computationally expensive to identify. This may conserve computing resources (e.g., processing resources, memory resources, communication resources, and/or power resources, among other examples) relative to prior systems for analyzing and detecting patterns in event data. The event sequence system may also surface patterns that may have otherwise gone undetected (e.g., due to the computational complexity associated with pattern identification and the amount of data being processed), enabling those patterns to be used for a variety of purposes. For example, the identified patterns may be useful for identifying problem areas associated with the source of the event data (e.g., problems in software or hardware), identifying events and event sequences of frequent interest or use, and/or filtering event data for more efficient processing, among other examples.

In some aspects, the event sequence system may identify a subset of data for pattern detection. For example, rather than analyzing an entire sequence of event data, portions of the event data may be excluded (e.g., by filtering types and/or values from the data). This may facilitate faster analysis (e.g., less data to be analyzed) and further conserve computing resources relative to performing analysis on an entire stream of event data or otherwise unfiltered event data.

In some aspects, tokenizing the event sequences may include compressing the event sequences. For example, the event sequences may be compressed based at least in part on a maximum token length threshold to limit the tokenization process. This may reduce the complexity of the analysis, improving the speed of the tokenization process and further conserving computing resources relative to processes that do not compress the data during tokenization and/or do not limit the token length.

In some aspects, the event data (also referred to herein as “event stream data”) may correspond to click stream data associated with user interactions, such as user interactions with an application (e.g., a web page or other software application). In this situation, the event sequence system may facilitate the identification of patterns in sequences of user interactions, such as frequent user interaction subsequences, in a manner that is computationally efficient. This may be useful for identifying problems associated with the application, areas of interest associated with the application, and other patterns that may not otherwise be identifiable in a computationally efficient manner.

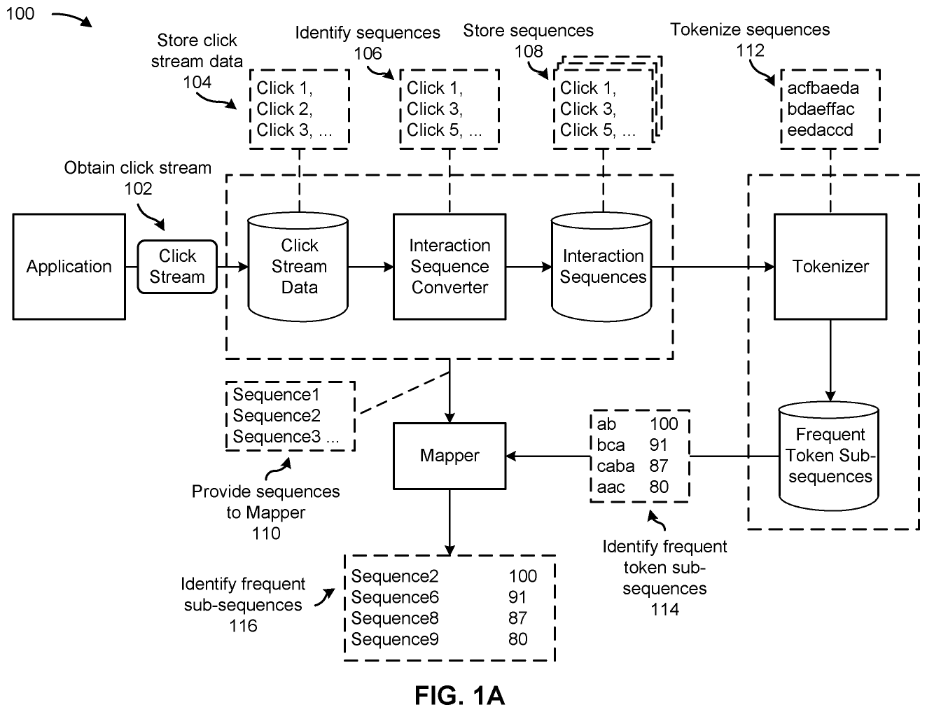

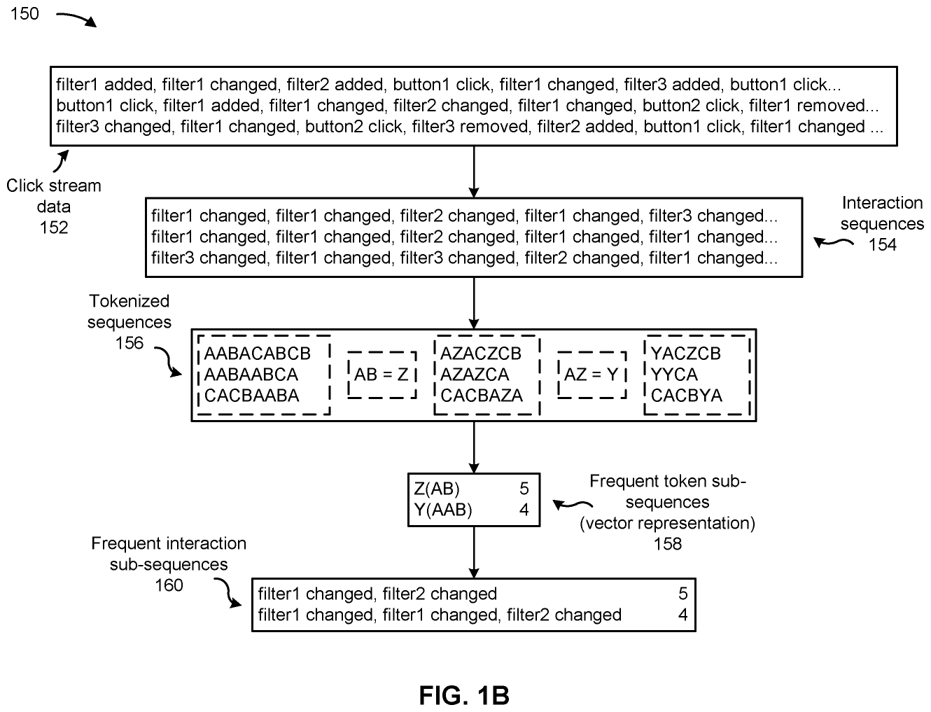

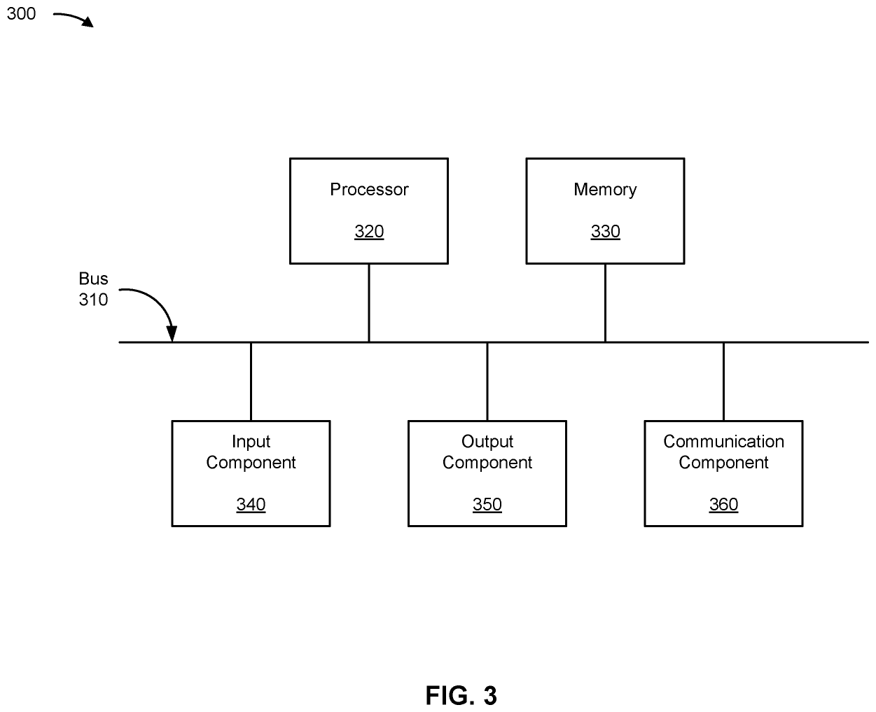

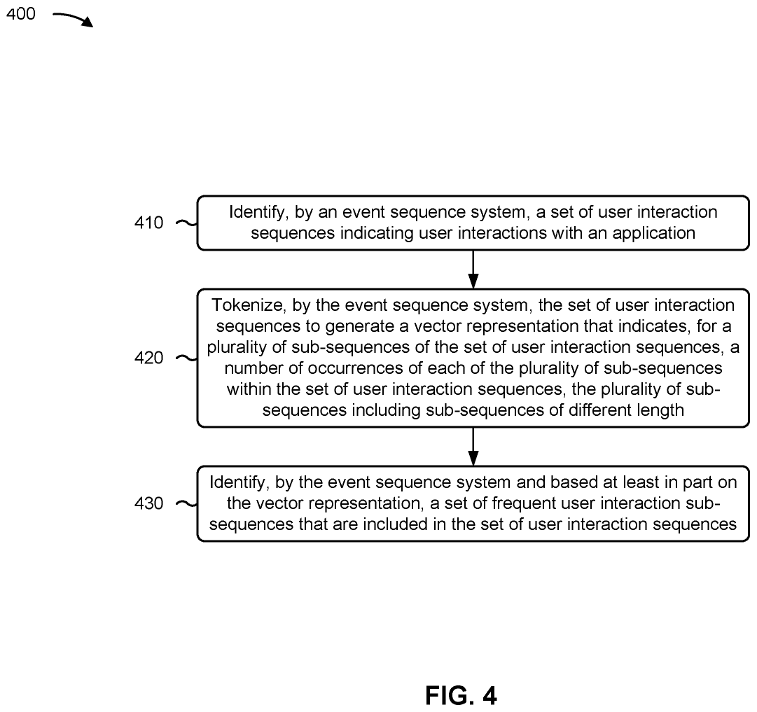

FIGS. 1A-1B are diagrams of an example 100 associated with detecting patterns in event data. In particular, example 100 depicts various components, devices, and features associated with detecting frequent sub-sequences within sequences of click stream data associated with an application. As shown in FIGS. 1A-1B, example 100 includes an event sequence system and multiple devices and/or components (e.g., an application, interaction sequence converter, tokenizer, and mapper). These devices are described in more detail in connection with FIGS. 3 and 4.

As shown by reference number 102, an event sequence system may obtain click stream data. The click stream data may indicate user interactions with an application. For example, the click stream data may include a stream of data that indicates portions of a website that one or more users have interacted with over time and may include information indicating types of user interactions, portions of the website interacted with, and/or values associated with the user interactions, among other examples. The click stream data may be separated on a per user basis, combined together for multiple users, or both. In the context of an e-commerce website, for example, the click stream data may indicate user interactions with filters, product pages, and purchase buttons.

As shown by reference number 104, the event sequence system may store the click stream data. For example, the click stream data may be stored as a time-ordered list of clicks, or user interactions, with the application.

As shown by reference number 106, the event sequence system may identify a set of user interaction sequences indicating user interactions with the application. For example, the set of user interaction sequences may be specific types of interactions within the click stream data. In some aspects, the set of user interaction sequences may be a subset of the click stream data (e.g., a subset of user interactions with the application). By using a subset of the click stream data, the event sequence system may reduce the amount and complexity of the data while potentially providing more meaningful analysis. For example, the set of user interaction sequences may focus on filter interactions within the click stream data as a means to analyze and extract subsequences representing user filter and/or search preferences.

In some aspects, the set of user interaction sequences may include categorical univariate time series data. For example, an interaction sequence converter component of the event sequence system may transform the click stream data into a series of filter interactions, which can be represented as categorical univariate time series.

In some aspects, the set of user interaction sequences may comprise user interactions with the application from a plurality of different users. For example, the click stream data may be collected from multiple users interacting with the application, allowing for analysis of user behavior across a diverse set of users.

As shown by reference number 108, the event sequence system may store the user interaction sequences for later processing. In addition, as shown by reference number 110, the event sequence system may provide the user interaction sequences to a mapper component or device. The mapper stores the user interaction sequences for later mapping from tokenized sub-sequences, which may enable the event sequence system to output non-tokenized versions of frequent sub-sequences.

As shown by reference number 112, the event sequence system may tokenize the set of user interaction sequences to generate a vector representation that indicates, for sub-sequences of the set of user interaction sequences, a number of occurrences of each of the sub-sequences within the set of user interaction sequences. For example, the event sequence system may generate a vector representation that indicates how often different sub-sequences of user interaction sequences occur within the larger dataset of user interaction sequences. The sub-sequences may include sub-sequences of different lengths. For example, the event sequence system may tokenize user interaction sequences to identify sub-sequences of varying lengths, such as 2, 3, 4, or more interactions, to capture a range of relevant user interactions.

In some aspects, the event sequence system may compress the set of user interaction sequences when tokenizing the set of user interaction sequences. For example, the event sequence system may use tokenization to reduce the size of the data set while retaining important information about user interactions. In some aspects, the event sequence system may compress the set of user interaction sequences based at least in part on a maximum token length threshold. For example, the event sequence system may set a maximum token length threshold to ensure that the tokenization process focuses on capturing meaningful sub-sequences without generating tokens that are too long and lose meaning for interpretation. Compressing the user interaction sequences may also conserve computing resources associated with processing the user interaction sequences (e.g., by decreasing the amount of data stored and processed).

In some aspects, the event sequence system may tokenize the set of user interaction sequences using byte pair encoding. For example, the event sequence system may apply a byte pair encoding technique to generate sub-sequences and compress the set of user interaction sequences. After tokenization, the event sequence system may store the tokenized user interaction sequences for subsequent processing. For example, the output of the tokenization process may include a vector representation and/or multiple vector representations of one or more user interaction sub-sequences.

As shown by reference number 114, the event sequence system may identify, based at least in part on the vector representation(s), a set of frequent token sub-sequences that are included in the set of tokenized sub-sequences. In some aspects, the event sequence system may map the vector representation to the plurality of sub-sequences. For example, the event sequence system may obtain one or more vector representations of tokenized user interaction sub-sequences and map those user interaction sub-sequences to previously stored user interaction sequences to identify frequent user interaction sub-sequences.

As shown by reference number 116, in some aspects, the set of frequent user interaction sub-sequences may comprise N most frequent user interaction sub-sequences. For example, the event sequence system may identify the top N (e.g., wherein N is a positive integer) most frequent sub-sequences to provide as output for further processing and/or analysis. For example, the most frequent user interaction sub-sequences may provide insights into potential problems with the application and/or user behavior and preferences associated with the application, among other examples.

While the components and/or devices depicted in FIG. 1A are shown separately, some or all of the devices and/or components may be included in the event sequence system, as described further herein.

FIG. 1B depicts a specific example 150 of detecting patterns in event data and click stream data in particular. As shown by reference number 152, the event sequence system may obtain click stream data that includes time-ordered sets of user interactions with an application. As shown by reference number 154, the event sequence system identifies a subset of the click stream data for processing. In this example, only filter change interactions are identified for further processing and analysis, dropping user interactions associated with button clicks.

As shown by reference number 156, the event sequence system tokenizes the identified user interaction sequences to created tokenized sequences. For example, the user interactions filter1 changed, filter2 changed, and filter3 changed correspond to tokens A, B, and C, respectively. Using byte-pair encoding, the most frequently occurring token sub-sequence (AB) can be replaced by a new token, Z. This process may continue, replacing the next most frequently occurring sub-sequence (AZ, which is AAB) by a new token, Y.

As shown by reference number 158, the event sequence system identifies the most frequently occurring sub-sequences from a vector representation of the tokens. For example, the token Z (corresponding to the token sub-sequence AB) occurs five times in the example data set, while the token Y (corresponding to the token sub-sequence AAB) occurs four times in the example data set. As shown by reference number 160, the most frequent token sub-sequences (e.g., Z=AB and Y=AAB) are mapped back to the corresponding user interactions, providing output indicating that the sub-sequence of filter1 changed, filter2 changed is most frequently occurring, while the sub-sequence of filter1 changed, filter1 changed, filter2 changed is the second most frequently occurring.

Over a large data set, the processes described herein for detecting patterns in event data may enable the identification of patterns that would otherwise be difficult and computationally expensive to identify. This may conserve computing resources relative to prior systems for analyzing and detecting patterns in event data. The event sequence system may also surface patterns that may have otherwise gone undetected, enabling those patterns to be used for a variety of purposes. For example, the identified patterns may be useful for identifying problem areas associated with the source of the event data (e.g., problems in software or hardware), identifying events and event sequences of frequent interest or use, and/or filtering event data for more efficient processing, among other examples.

As indicated above, FIGS. 1A-1B are provided as an example. Other examples may differ from what is described with regard to FIGS. 1A-1B.

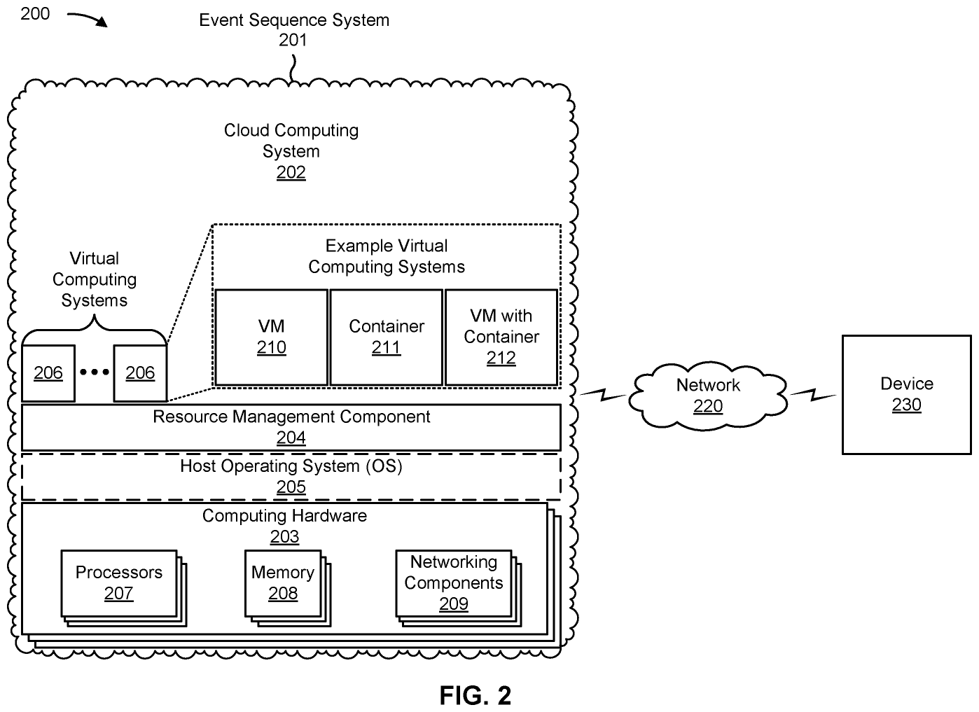

FIG. 2 is a diagram of an example environment 200 in which systems and/or methods described herein may be implemented. As shown in FIG. 2, environment 200 may include an event sequence system 201, which may include one or more elements of and/or may execute within a cloud computing system 202. The cloud computing system 202 may include one or more elements 203-212, as described in more detail below. As further shown in FIG. 2, environment 200 may include a network 220 and a device 230. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the event sequence system 201 may include one or more elements 203-212 of the cloud computing system 202, may execute within the cloud computing system 202, and/or may be hosted within the cloud computing system 202, in some implementations, the Event sequence system 201 may not be cloud-based (e.g., may be implemented outside of a cloud computing system) or may be partially cloud-based. For example, the Event sequence system 201 may include one or more devices that are not part of the cloud computing system 202, such as device 300 of FIG. 3, which may include a standalone server or another type of computing device. The Event sequence system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The device 230 may include any of the devices depicted in FIG. 1A, such as an application device (e.g., an application server, such as a web server) that provides event data for the event sequence system 201, an interaction sequence converter device that identifies data to be processed from the event data (e.g., identifies event sequences from click stream data), a tokenizer device that tokenizes sequences of event data for analysis (e.g., performs byte pair encoding on user interaction sequences to generate vector representations of the user interaction sequences), a mapper device that maps tokenized event sub-sequences back to the non-tokenized event data (e.g., maps frequent token sub-sequences into frequent user interaction sub-sequences) for further processing, analysis, and/or output.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with detecting patterns in event data. The device 300 may correspond to event sequence system 201 and/or device 230. In some implementations, event sequence system 201 and/or device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

FIG. 4 is a flowchart of an example process 400 associated with detecting patterns in event data. In some implementations, one or more process blocks of FIG. 4 may be performed by the event sequence system 201. In some implementations, one or more process blocks of FIG. 4 may be performed by another device or a group of devices separate from or including the event sequence system 201, such as the event sequence system 201 and/or the device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include identifying a set of user interaction sequences indicating user interactions with an application (block 410). For example, the event sequence system 201 (e.g., using processor 320 and/or memory 330) may identify a set of user interaction sequences indicating user interactions with an application, as described above in connection with reference number 106 of FIG. 1A. As an example, the event sequence system 201 may identify data representing a time-ordered series of clicks within click stream data for future processing.

As further shown in FIG. 4, process 400 may include tokenizing the set of user interaction sequences to generate a vector representation that indicates, for a plurality of sub-sequences of the set of user interaction sequences, a number of occurrences of each of the plurality of sub-sequences within the set of user interaction sequences, the plurality of sub-sequences including sub-sequences of different lengths (block 420). For example, the event sequence system 201 (e.g., using processor 320 and/or memory 330) may tokenize the set of user interaction sequences to generate a vector representation that indicates, for a plurality of sub-sequences of the set of user interaction sequences, a number of occurrences of each of the plurality of sub-sequences within the set of user interaction sequences, the plurality of sub-sequences including sub-sequences of different lengths, as described above in connection with reference number 112 of FIG. 1A. As an example, the event sequence system 201 may tokenize sequences of user interactions, representing the sequences in vector form to enable further processing and analysis.

As further shown in FIG. 4, process 400 may include identifying, based at least in part on the vector representation, a set of frequent user interaction sub-sequences that are included in the set of user interaction sequences (block 430). For example, the event sequence system 201 (e.g., using processor 320 and/or memory 330) may identify, based at least in part on the vector representation, a set of frequent user interaction sub-sequences that are included in the set of user interaction sequences, as described above in connection with reference number 114 of FIG. 1A. As an example, the event sequence system 201 may identify the N most frequently occurring token sub-sequences that represent the N most frequent user interaction sub-sequences.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for processing event data, the system comprising:
one or more memories; and
one or more processors, communicatively coupled to the one or more memories, configured to:
identify a set of user interaction sequences indicating user interactions with an application;
tokenize the set of user interaction sequences to generate a vector representation that indicates, for a plurality of sub-sequences of the set of user interaction sequences, a number of occurrences of each of the plurality of sub-sequences within the set of user interaction sequences,
the plurality of sub-sequences including sub-sequences of different lengths; and
identify, based at least in part on the vector representation, a set of frequent user interaction sub-sequences that are included in the set of user interaction sequences.

2. The system of claim 1, wherein the one or more processors are further configured to:
obtain click stream data indicating the user interactions with the application.

3. The system of claim 2, wherein the one or more processors, to identify the set of user interaction sequences, are configured to:
identify a subset of the user interactions with the application as the set of user interaction sequences.

4. The system of claim 1, wherein each of the set of user interaction sequences comprise categorical univariate time series data.

5. The system of claim 1, wherein the set of user interaction sequences comprises user interactions with the application from a plurality of different users.

6. The system of claim 1, wherein the one or more processors, to tokenize the set of user interaction sequences, are configured to:
tokenize the set of user interaction sequences to compress the set of user interaction sequences.

7. The system of claim 6, wherein the one or more processors, to tokenize the set of user interaction sequences, are configured to:
compress the set of user interaction sequences based at least in part on a maximum token length threshold.

8. The system of claim 1, wherein the one or more processors, to tokenize the set of user interaction sequences, are configured to:
tokenize the set of user interaction sequences using byte pair encoding.

9. The system of claim 1, wherein the one or more processors, to identify the set of frequent user interaction sub-sequences, are configured to:
map the vector representation to the plurality of sub-sequences.

10. The system of claim 1, wherein the set of frequent user interaction sub-sequences comprises N most frequent user interaction sub-sequences.

11. A method for processing event data, comprising:
identifying, by an event data processing system, a user interaction sequence indicating user interactions with an application;
tokenizing, by the event data processing system, the user interaction sequence to generate a vector representation that indicates, for a plurality of sub-sequences of the user interaction sequence, a number of occurrences of each of the plurality of sub-sequences within the user interaction sequence,
the plurality of sub-sequences including sub-sequences of different lengths; and
identifying, by the event data processing system and based at least in part on the vector representation, a set of frequent user interaction sub-sequences that are included in the user interaction sequence.

12. The method of claim 11, further comprising:
obtaining event stream data indicating the user interactions with the application.

13. The method of claim 12, wherein identifying the user interaction sequence comprises:
identifying a subset of the event stream data as the user interaction sequence.

14. The method of claim 11, wherein the interaction sequence comprises user interactions with a web page.

15. The method of claim 11, wherein tokenizing the user interaction sequence comprises:
tokenizing the user interaction sequence to compress the user interaction sequence.

16. The method of claim 15, wherein tokenizing the user interaction sequence comprises:
compressing the user interaction sequence until token sub-sequences satisfy a token length threshold.

17. The method of claim 11, wherein tokenizing the user interaction sequence comprises:
tokenizing the user interaction sequence using byte pair encoding.

18. The method of claim 11, further comprising:
mapping the vector representation to the plurality of sub-sequences.

19. The method of claim 11, wherein the set of frequent user interaction sub-sequences comprises N most frequent user interaction sub-sequences.

20. A non-transitory computer-readable medium storing a set of instructions, the set of instructions comprising:
one or more instructions that, when executed by one or more processors of an event data processing system, cause the event data processing system to:
identify a user interaction sequence indicating user interactions with an application;
tokenize the user interaction sequence to generate a vector representation that indicates, for a plurality of sub-sequences of the user interaction sequence, a number of occurrences of each of the plurality of sub-sequences within the user interaction sequence,
the plurality of sub-sequences including sub-sequences of different lengths; and
identify, based at least in part on the vector representation, a set of frequent user interaction sub-sequences that are included in the user interaction sequence.
